(19) United States
(12) Patent Application Publication
(10) Pub. No.: US 2010/0023677 A1
(43) Pub. Date: Jan. 28, 2010

(54) SOLID STATE STORAGE SYSTEM THAT EVENLY ALLOCATES DATA WRITING/ERASING OPERATIONS AMONG BLOCKS AND METHOD OF CONTROLLING THE SAME

(76) Inventors: Young Kyun SHIN, Gyeonggi-do (KR); Dae Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/395,755

(22) Filed: Mar. 2, 2009

(30) Foreign Application Priority Data
Jul. 28, 2008 (KR) 10-2008-0073560

(51) Int. Cl. G06F 12/00; G06F 12/02; G06F 12/06

(52) U.S. Cl. 711/103; 711/170; 711/E12.001; 711/E12.002; 711/E12.008; 711/E12.078

(57) ABSTRACT

A solid state storage system that evenly allocates data writing/erasing operations among blocks is presented. The solid state storage system includes a controller. The controller is configured to set a representative value that becomes a block allocation reference in accordance with predetermined information of blocks in a flash memory area. The controller is also configured to calculate a data value that becomes life time information according to the predetermined information in a current state for each block. The controller is also configured to determine a block where a deviation is generated between the representative value and the data value. The controller is also configured to allocate block where the deviation is generated as a new block where data is written.

### CROSS-REFERENCES TO RELATED PATENT APPLICATION

The present application claims priority under 35 U.S.C 119(a) to Korean Application No. 10-2008-0073560, filed on Jul. 28, 2008, in the Korean Intellectual Property Office, which is incorporated herein by reference in its entirety as set forth in full.

### BACKGROUND

1. Technical Field

The embodiment described herein relates to a solid state storage system and a method of controlling the solid state storage system, and more particularly, to a solid state storage system that can control allocation of memory blocks and a method of controlling the solid state storage system.

2. Related Art

In general, non-volatile memories have been used as memories for portable information apparatuses. In recent years, instead of a hard disk drive (HDD), a solid state drive (SSD) using a NAND flash memory has begun to be used in a personal computer (PC). Therefore, it is anticipated that the SSD will make inroads into the share market of the HDD.

A solid state storage system using the flash memory includes a memory area that is composed of a plurality of blocks that include a plurality of pages. Because of a characteristic of the flash memory, data is written in a page unit but is updated or erased in a block unit. That is, in order to update contents of a page where arbitrary data is stored, the entire block including the corresponding page is first erased, and then data needs to be written again in a page unit.

Meanwhile, the life time of the flash memory is restricted by an erase cycle or an erase count of a block. In general, as a type of a cell that constitutes the flash memory, in the case of a single level cell (SLC), when data is erased, at say, 100,000 times, the life time of the cell is terminated. In the case of a multi level cell (MLC), when data is erased, at say, 5000 to 10,000 times, the life time of the cell is terminated. Accordingly, in order to efficiently use the SSD, erase cycles or erase counts of all areas (for example, ‘blocks’) of the flash memory need to be uniformly controlled.

As a control method, a method that stores and updates an erase count for each block so as not to continuously allocate a specific block or a method that allocates a physical block having a small erase count when an erase count reaches a maximum erase count has been introduced. However, a size of a buffer unit that stores erase count information of a block reaches the limit. For example, the buffer unit may be a buffer using an SRAM memory. As described above, in order to count 100,000 cycles that correspond to an erase count in the case of the SLC, a data space of the buffer unit of 4 Bytes is needed for each block to allocate a corresponding information space. If the data space in each block is applied to all blocks, a wide data space is needed. Accordingly, if the erase counts of all of the blocks are managed while the buffer unit of the restricted size is used, performance of the entire system may be deteriorated. Meanwhile, if the size of the buffer unit is increased to improve system performance, then the chip area efficiency and cost of the system increase, and as a results the productivity is lowered.

### SUMMARY

A solid state storage system that can control uniform utilization of blocks is disclosed herein.

A method of controlling a solid state storage system that can coordinate uniform utilization of blocks is disclosed herein.

In one aspect, a solid state storage system includes a controller configured to set a representative value that becomes a block allocation reference in accordance with predetermined information of blocks in a flash memory area, calculate a data value that becomes life time information according to the predetermined information in a current state for each block, determine a block where a deviation is generated between the representative value and the data value, and allocate the block where the deviation is generated as a new block where data is written.

In another aspect, a solid state storage system includes a flash memory area configured to include a plurality of planes having a free block and a data block; a controller configured to set a representative value according to a statistical value of predetermined information of the free block and the data block, calculate a data value that becomes life time information according to the predetermined information in a current state for each block, and determine priority of block allocation using a deviation between the representative value and the data value; and a buffer unit configured to update and store the data value for each block, when a write operation is performed.

In another aspect, a method of controlling a solid state storage system includes allowing a controller to set a representative value that becomes a block allocation reference in accordance with predetermined information of blocks and calculate a data value that becomes life time information according to the predetermined information of each block in a current state for each block; determining whether there are blocks in which a deviation between the representative value and the data value is a predetermined value or less, when data is processed in accordance with a command from an external host; and performing a write operation when the corresponding blocks exist and allowing the controller to initialize information of all of the blocks when the corresponding blocks do not exist.

According to one embodiment, a memory area can be controlled to be uniformly used, by setting a representative value that can become a life time reference of the memory area and managing deviations from the representative value. Further, the life time of cells between planes or chips can be equalized by making continuous addresses mapped to different blocks. Therefore, restricted resources can be efficiently used.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a block diagram of a solid state storage system according to one embodiment;

FIG. 2 is a conceptual block diagram of a memory area shown in FIG. 1;

FIG. 3 is a block diagram of an MCU and a buffer unit shown in FIG. 1;

FIG. 4 is a diagram illustrating an example of when a representative value and a data value of a block shown in FIG. 1 are calculated;

FIGS. 5A to 5E are conceptual block diagrams of the case where allocation information of a data block and a free block is updated in an intra-block data value storage unit as time passes;

FIG. 6 is a conceptual block diagram of a write count storage unit shown in FIG. 3;

FIG. 7 is a block diagram of an MCU according to another embodiment;

FIG. 8 is a block diagram of a memory area shown in FIG. 7;

FIG. 9 is a flowchart illustrating a method of controlling a solid state storage system according to one embodiment; and

FIG. 10 is a flowchart illustrating a method of controlling a solid state storage system according to another embodiment.

### DETAILED DESCRIPTION

Hereinafter, a solid state storage system and a method of controlling the solid state storage system according to one embodiment will be described with reference to the accompanying drawings.

Each block of the block diagrams can represent a module, segment, or portion of code, which includes one or more executable instructions for implementing the specified logical function(s). It should also be noted that in some alternative implementations, the functions noted in the blocks can occur out of order. For example, two blocks shown in succession can in fact be substantially executed concurrently or the blocks can sometimes be executed in reverse order depending upon the functionality involved.

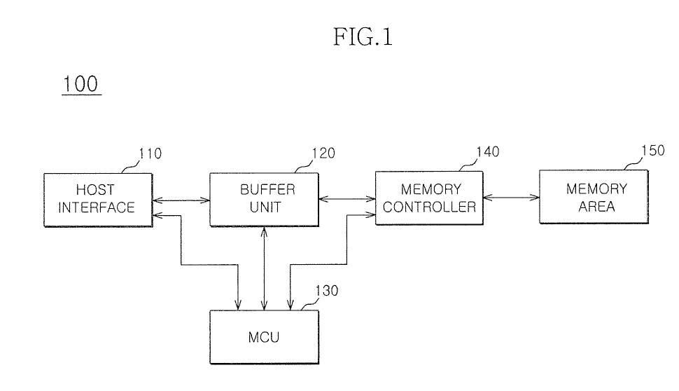

First, a solid state storage system according to one embodiment will be described with reference to FIGS. 1 to 8.

FIG. 1 is a block diagram of a solid state storage system 100 according to one embodiment. In this case, the solid state storage system 100 is exemplified as a storage system using a NAND flash memory.

Referring to FIG. 1, the solid state storage system 100 can be configured to include a host interface 110, a buffer unit 120, a micro controller unit (MCU) 130, a memory controller 140, and a memory area 150.

First, the host interface 110 can be connected to the buffer unit 120. The host interface 110 can transmit and receive control commands, address signals, and data signals between an external host (not shown) and the buffer unit 120. An interface method between the host interface 110 and the external host (not shown) can be any one of a serial advanced technology attachment (SATA) method, a parallel advanced technology attachment (PATA) method, a SCSI method, a method using an express card, and a PCI-Express method, which are only exemplary interface methods.

The buffer unit 120 can buffer output signals from the host interface 110 or store mapping information between logical addresses and physical addresses and block allocation information of a memory area. The buffer unit 120 can be a buffer using a static random access memory (SRAM). In particular, according to one embodiment, since block allocation reference information of the memory area can be represented by a small amount of bits as compared with the related art, the buffer unit 120 can have a smaller size than the buffer unit according to the related art.

The MCU 130 can exchange control commands, address signals, and data signals with the host interface 110 or control the memory controller 140 using the above signals.

In particular, the MCU 130 according to one embodiment can set a representative value RV that can become a block allocation reference in the memory area 150 and perform a control operation such that all blocks are uniformly used, using the representative value.

Specifically, the MCU 130 can set the representative value that can become a block allocation reference so as to be represented by a small amount of bits, instead of an erase count that requires a large amount of bit information. The representative value can be set in consideration of a size of each block in the memory area, the number of pages in each block or the number of sectors, and a record (or write) count. The representative value will be described in detail below.

When a write command is provided from the external host, the MCU 130 can preferentially trace blocks where a deviation of a predetermined value (for example, data value) of each block from the set representative value is large and can allocate the traced blocks as blocks where data is written. The MCU 130 can control uniform utilization of all of the blocks by setting the representative value and managing a deviation between the representative value and the data value for each block. Here, the MCU 130 controls the block allocation. However, separate firmware or software, or a dedicated processor can be additionally provided so as to control the block allocation.

Further, if the representative value indicates a threshold value of a write count for each block, in order to control whether the write count reaches a physical maximum write count of each block, then the representative value needs to be updated and managed, whenever the representative value is updated.

The operation of the MCU 130 and a control method thereof will be described in detail below with reference to FIG. 3.

The memory controller 140 can select a predetermined NAND flash memory element ND from a plurality of NAND flash memory elements of the memory area 150, and can provide a write command, an erase command or a read command to the selected NAND flash memory element. The memory controller 140 can be controlled by the MCU 130, and preferentially can select blocks that have large deviations from the representative value in accordance to a block control method of the MCU 130, when a write operation is performed, and can allocate the selected blocks as blocks where data is written.

The memory area 150 can be controlled by the memory controller 140 and data write, erase, and read operations can be performed in the memory area 150. Here, the memory area 150 can, for example, be a NAND flash memory. For convenience of explanation, in one embodiment, the memory area 150 is exemplified as an SLC NAND flash memory, but can be an MLC NAND flash memory. Also, the memory area 150 can include the SLC NAND flash memory and the MLC NAND flash memory.

The memory area 150 can be configured to include a plurality of chips, each of which includes a plurality of blocks that include a plurality of pages.

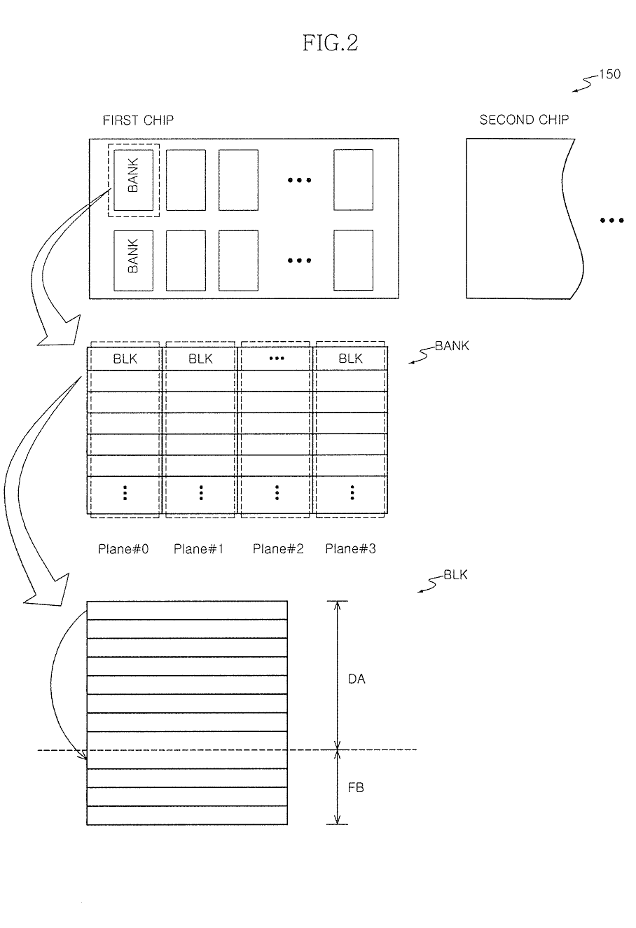

FIG. 2 is a conceptual block diagram of the memory area 150.

Referring to FIG. 2, the memory area 150 can be configured to include a plurality of chips (a first chip, a second chip, . . . ). Each of the chips can be configured to include a plurality of banks, and each of the banks can be configured to include a plurality of planes where a plurality of memory blocks BLK are grouped. Each of the memory blocks BLK can be configured to include a plurality of pages (or sectors) that are grouped on the basis of shared word lines.

As well known, each of the blocks BLK can be configured to include a main block where a predetermined area is allocated including available pages and which includes a spare block including surplus pages. The main block can be called a data area DA and the spare block can be called a free area FB. Meanwhile, in this case, one block can include the data area DA and the free area FB. However, even in the planes where the plurality of blocks in the bank are grouped, the blocks that are allocated to store data can be extended as data blocks and the surplus blocks can be extended as free blocks. That is, the data block and the free block in the same plane are extended concepts of the data area and the free area in an arbitrary block. Hereinafter, in the description of the block allocation, the data block and the free block in the same plane will be described.

Since the flash memory is a non-volatile memory, new data cannot be overwritten in a page where data is written. Thus, after data is erased in a block unit, new data can be written. Accordingly, write and erase processes are necessarily required in order to update data.

If data is continuously updated in only the same block, aging of the corresponding block is accelerated. As described above, since an erase count of a block becomes an important reference in the related art, block allocation is managed using the erase count.

However, according to one embodiment, when a data write operation is requested, the blocks can be allocated in consideration of deviations of the data values of the individual blocks from the representative value that can be represented by a small amount of bits. Further, when the write operation is requested, if the free blocks are made to have high priority and specific information or data values of the free blocks approximate to the representative value, block allocation can be controlled such that specific information or data values of the data blocks approximate to the representative value. The representative value, the data value, and the block allocation will be described in detail with reference to FIG. 3.

FIG. 3 is a block diagram of a buffer unit 120 and an MCU 130 shown in FIG. 1.

Referring to FIG. 3, first, the buffer unit 120 can be configured to include an intra-block data value storage unit 122 and a write count storage unit 124. The MCU 130 can be configured to include a representative value setting unit 132 and a block control unit 134. Although not shown, each of the buffer unit 120 and the MCU 130 can include additional functional blocks.

First, the representative value that becomes an allocation reference of each block is set by the representative value setting unit 132 of the MCU 130.

In this case, the representative value RV is used to indicate a logical maximum write count of each block.

In general, a work load is first analyzed in order to monitor performance of the solid state storage system 100. At this time, the representative value setting unit 132 can then set the representative value RV using analyzed data. That is, the representative value setting unit 132 can analyze scanned block information of the memory area (refer to reference numeral 150 of FIG. 1), and collect statistics about access counts of blocks in the memory area (refer to reference numeral 150 of FIG. 1) or write counts thereof. As a result, the predetermined count in each block can be set as a utilization index of each block. For example, using an average count written in each block (median or mean) or a count written most in each block (mode) as the utilization index, it is possible to calculate the representative value RV that considers the size of each block and the number of pages in each block.

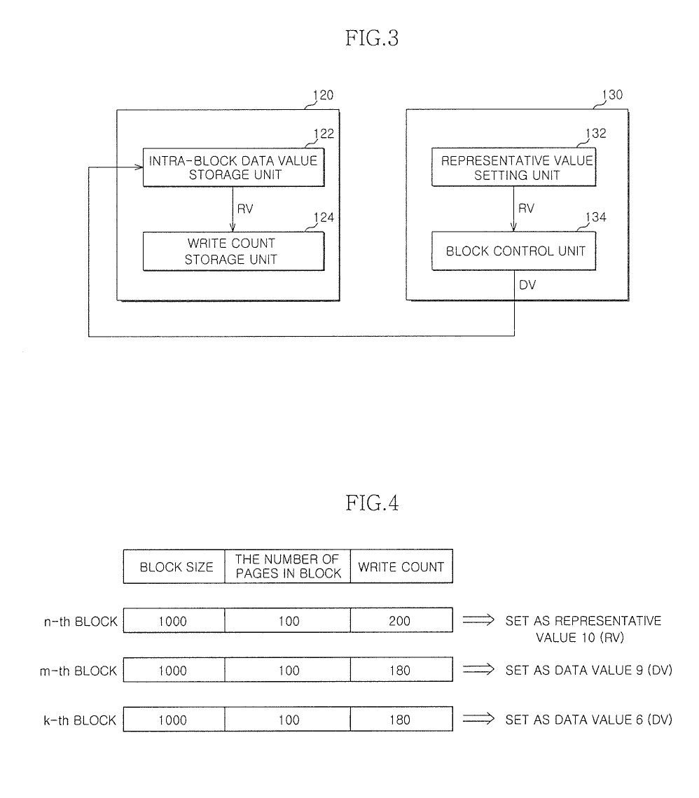

FIG. 4 is a conceptual diagram of the case where a representative value RV and a data value DV of an arbitrary block are determined. In this case, a count that becomes a reference of the limit of the life time is set as the representative value RV on the basis of a logical write count. That is, when the arbitrary block has the restricted size and the restricted number of pages, a maximum write count in the arbitrary block (blocks) can become a reference of the limit of the life time of the corresponding block. Further, the data value DV indicates a value where a substantial write count in a current state is applied.

Referring to FIG. 4, first, the representative value RV can be set by the statistical analysis through the above-described work load. For example, it is assumed that the size of a predetermined block, for example, an n-th block, the number of pages in the block, and a write count in the block are 1000, 100, and 200, respectively. On the basis of the above example, the representative value RV as the maximum write count can be set as 10. If the representative value RV is set, the number of samples, that is, blocks can be arbitrarily set, such that the representative value RV can become a measurement index indicative of the life time of a cell. It is preferable that the representative value RV be calculated using a relatively large number of blocks for sampling purposes because the life time management of the cell can be more accurately estimated.

Then, when it is assumed that the size of an arbitrary m-th block, the number of pages in the block, and an actual write count in the block are 1000, 100, and 180, respectively, the representative value RV can be set as a data value 9. Likewise, when it is assumed that the size of an arbitrary k-th block, the number of pages in the block, and a write count in the block are 1000, 100, and 120, respectively, the representative value RV can be set as a data value 6. However, the above examples are only to illustrate a calculation relationship between the data value DV and the representative value RV, for convenience of explanation. For example, a write count that becomes a predetermined reference as the representative value RV can be used without a conversion. However, the representative value RV indicates a logical write count in each block and can be any one of values that are represented by a small amount of bits, as compared with a physical maximum write count in each block.

Referring to FIG. 3 again, after setting the representative value RV that becomes a block allocation reference through the statistical analysis, the representative value setting unit 132 can calculate the data value DV using predetermined information (the size of each block, the number of pages in each block, and an actual write count in each block) of each block. The representative value RV and the data value DV are exemplified as information that can be represented by a maximum of 1 Byte. According to one embodiment, it is possible to decrease the size of the buffer unit 120 that temporarily stores information of each block. The block control unit 134 can manage a deviation of the data value DV from the set representative value RV and allocate blocks.

That is, when a write operation is requested from the external host, the block control unit 134 determines the representative value RV as a limitative value or as a threshold value and preferentially allocates a block where a deviation of the data value DV from the representative value RV is largest.

Specifically, the block control unit 134 determines that a block, which has the largest deviation from the representative value RV, is a block having the lowest use frequency or record frequency and allocates the corresponding block as a new block where data is written. That is, the block control unit 134 gives priority over block allocation to blocks that have large deviations from the representative value RV. If the above process is repeated, data values DV of all of the blocks increase, thus, deviations with the representative value RV can gradually decrease.

Meanwhile, the intra-block data value storage unit 122 of the buffer unit 120 stores counting information for the data value DV from the block control unit 134. That is, the intra-block data value storage unit 122 stores the data value DV that is updated whenever a write command is executed. If the data value DV that is stored in the intra-block data value storage unit 122 becomes equal to the representative value RV or approximates that of the representative value RV, then the intra-block data value storage unit 122 is initialized by the MCU 130.

Then, the write count storage unit 124 is updated by adding a ‘logical write count’ that is indicated by the representative value RV of each block, whenever the intra-block data value storage unit 122 is initialized. That is, the write count storage unit 124 can add a write count of, for example, 200 times that is indicated by the representative value RV whenever the intra-block data value storage unit 122 is initialized, and store the write count until the write count approximates to a physical maximum write count. In other words, since the intra-block data value storage unit 122 is initialized in a state where the intra-block data value storage unit 122 manages deviations, it indicates that data is written in all of the blocks in accordance with an approximate value of the representative value RV at the initialization point of time. Accordingly, the write count storage unit 124 can increment the write count by a logical write count that is indicated by the representative value RV and store the write count, whenever the intra-block data value storage unit 122 is initialized. The write count storage unit 124 can store a physical maximum write count, that is, a write count of for example between 5000 to 100,000. Accordingly, in this case the write count storage unit 124 can have the size of 4 Bytes.

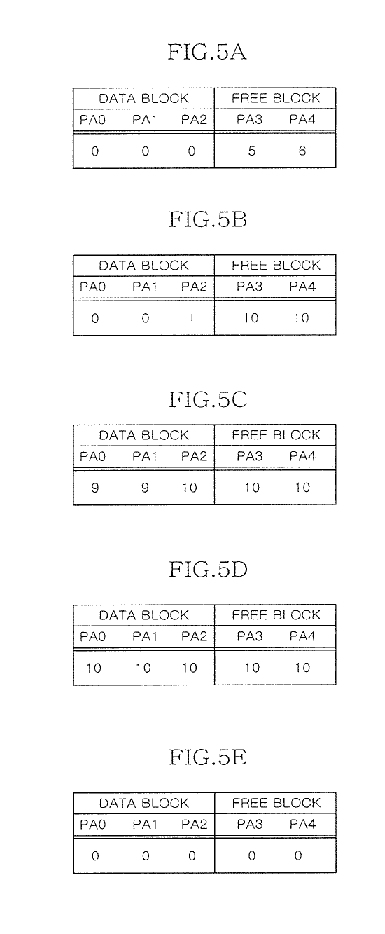

FIGS. 5A to 5E show a state where data values DV of a data block and a free block in the same plane are stored in an intra-block data value storage unit 122 shown in FIG. 3.

An arbitrary plane can be configured to include a data block and a free block, each of which includes a plurality of blocks, as described above. The blocks of the data block and the free block correspond to physical addresses PA0 to PA2 and PA3 to PA4. In this case, for convenience of explanation, the calculated representative value is exemplified as 10 and blocks in each area are allocated on the basis of the representative value.

FIGS. 5A to 5E show a process in which values of a data block and a free block vary as a predetermined amount of time passes.

First, referring to FIG. 5A, the blocks PA3 and PA4 in the free block have data values of 5 and 6, respectively. According to one embodiment, when blocks having large deviations from the representative value are allocated, the blocks in the free block are first allocated. Accordingly, the blocks PA0 to PA2 in the data block exist as areas that are not allocated.

After a predetermined time, as shown in FIG. 5B, when the data value DV of each of the blocks PA3 to PA4 in the free block is equal to the representative value RV, a deviation from the representative value is not generated in each block. Accordingly, allocation of the blocks PA0 to PA2 in the data block is initiated by the block control unit (refer to reference numeral 134 of FIG. 3).

As shown in FIG. 5C, allocation frequencies of the blocks PA0 to PA2 in the data block are 9, 9, and 10, respectively. Therefore, it can be understood that areas of the blocks are uniformly allocated such that large deviations from the representative value RV are not generated.

FIG. 5D illustrates a situation where a data value DV of each of a data block and a free block in all areas has the representative value RV, that is, an allocation count is satisfied by a threshold value of allocation.

FIG. 5E illustrates a situation where all of the blocks are initialized when all of the blocks satisfy a maximum value of allocation. That is, if a deviation between the data value DV and the representative value RV of each of the blocks is a predetermined value or less (for example, 0), information of all of the blocks is copied into a new plane and information of the corresponding blocks is initialized.

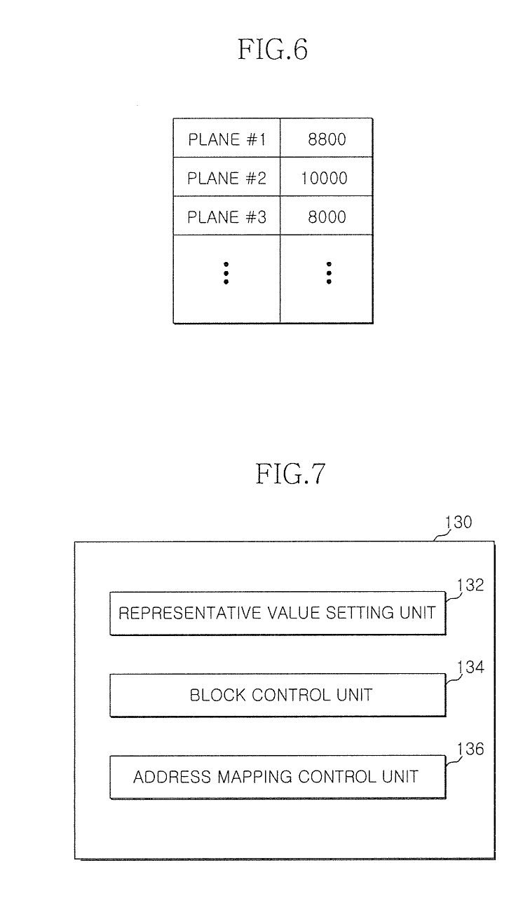

FIG. 6 is a conceptual diagram of a write count storage unit 124.

Referring to FIG. 6, the write count storage unit 124 increments a write count by a logical write count that is indicated by the representative value RV and stores the write count, whenever each plane is initialized.

That is, when the representative value RV indicates a write count of 200 times, a first plane (plane #1) can indicate a state where an initialization process is performed about 44 times, a second plane (plane #2) can indicate a state where an initialization process is performed about 50 times, and a third plane (plane #3) can indicate a state where an initialization process is performed about 40 times.

Accordingly, according to one embodiment, the data block and the free block can be uniformly used by determining a block allocation order determined using a deviation between the data value DV and the representative value RV. Further, since the size of the intra-block data value storage unit 122 of the buffer unit 120 can be reduced using the representative value RV that is represented by a small amount of bits, manufacturing costs can be reduced.

In the related art, as represented by Equation 1, each plane includes 2048 blocks, and each block needs an erase count storage unit that has the size of 4 Bytes.

One plane (=2048 blocks)*4 Byte=8192 Byte [Equation 1]

However, according to one embodiment, the representative value can be indirectly calculated, deviations can be managed on the basis of the representative value, and only a storage unit that stores a physical maximum write count needs to have a large size. Therefore, as compared with the related art, a buffer unit (refer to reference numeral 120 of FIG. 3) that has a small size can be included, as can be seen from Equation 2.

One plane (=2048 blocks)*1 Byte+4 Byte (write count storage unit)=2052 Byte [Equation 2]

FIG. 7 is a block diagram of an MCU 130 according to another embodiment.

Referring to FIG. 7, the MCU 130 according to another embodiment can be configured to include a representative value setting unit 132, a block control unit 134, and an address mapping control unit 136.

A difference between one embodiment shown in FIG. 3 and another embodiment will be described in detail.

In particular, according to one embodiment, the address mapping control unit 136 can use an FTL conversion to distribute and map logical addresses to planes of the entire memory area. That is, in the related art, physical addresses are sequentially increased for locations of pages in the same plane as a physical area where data is substantially stored. Further, logical addresses are also mapped to sequentially increase in the same plane. However, according to another embodiment, continuous logical addresses are controlled to designate blocks in different planes. That is, the MCU 130 performs a control operation such that the logical addresses are sequentially mapped to the different planes using the FTL conversion.

Specifically, the logical addresses and the physical addresses of the data storage area are mapped using the FTL conversion. Then, if referring to the logical addresses according to a command from the external host (not shown), data can be written, erased, and read at the locations that are designated by the physical addresses that are mapped to the logical addresses. As well known, each physical address is positional information of a page or a sub-block of the memory area.

That is, the MCU 130 performs a control operation such that the continuous logical addresses are sequentially mapped to the different planes using the FTL conversion.

The above structure will be described in detail with reference to the following drawing.

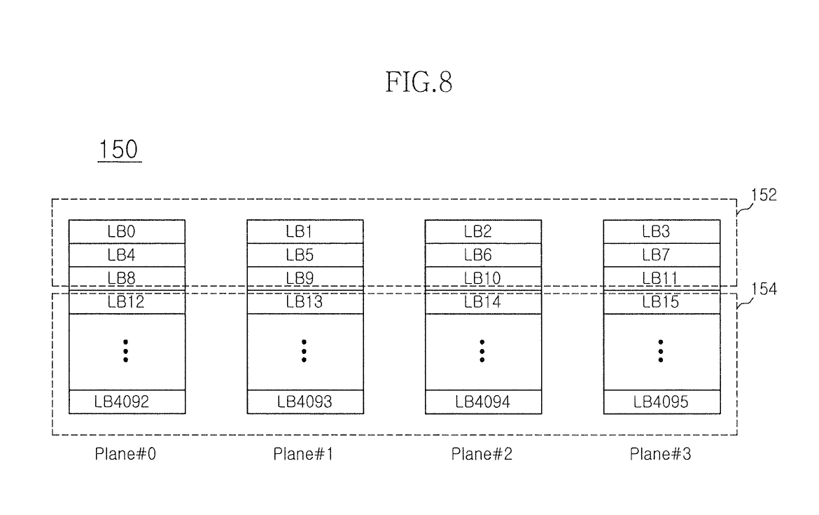

FIG. 8 is a block diagram of a memory area 150 that is controlled by an MCU 130 shown in FIG. 7.

Referring to FIG. 8, as described above, mapping addresses of logical addresses LB in the same block of the memory area 150 increase by the number of planes in the memory area (refer to reference numeral 150 of FIG. 3).

The memory area 150 can be configured to include a first data area 152 and a second data area 154.

The first data area 152 includes a first logical address group where logical addresses LB0 to LB11 are grouped. The second data area 154 includes a second logical address group where logical addresses LB12 to LB4095 are grouped. The first data area 152 can store data that is referred to by the first logical address group (of the logical addresses LB0 to LB11) and the second data area 154 can store data that is referred to by the second logical address group (of the logical addresses LB12 to LB4095).

According to one embodiment, the first data area 152 can store data that has a low write frequency attribute and the second data area 154 can store data that has a high write frequency attribute. In contrast, the first data area 152 can store data that has a high write frequency attribute and the second data area 154 can store data that has a low write frequency attribute.

As described above, according to attribute of an OS and application write data, large unit (bulk unit) data is continuously written. These data files have a low update frequency attribute. Accordingly, the data files have a write or erase frequency of once or within several times. The data can be preferentially written in the first data area 152 by the continuous logical addresses. According to another embodiment, since the logical addresses LB are continuously mapped between the planes, the large unit OS and application write data can be distributed to pages in different planes in the first data area 152 by the continuous logical addresses LB and written.

Meanwhile, the second data area 154 can store data that is related to a control code and a command that need to be occasionally updated according to the intention of the user and a command. Like this, data having a high use frequency can be uniformly distributed to planes in the second data area 154 by continuous logical addresses LB.

According to one embodiment, a data group having a high use frequency and a data group having a low use frequency coexist for each of the planes (a plane #0 to a plane #3). For example, in the case of a single level cell (SLC), the representative value can be set as 10. Allocation of blocks of different planes can be controlled on the basis of the set representative value RV.

Since a data group having a high data use frequency and a data group having a low data use frequency coexist for each plane in accordance with an address mapping method, the life time deviation between the planes can be reduced. Further, the life time of cells can be efficiently and uniformly controlled by allocating blocks through a deviation management.

For convenience of explanation, the block is exemplified herein, but a description can be made on the basis of a single chip. Accordingly, according to one embodiment, in the memory area that includes a plurality of chips (not shown), the life time deviation between the chips can be reduced.

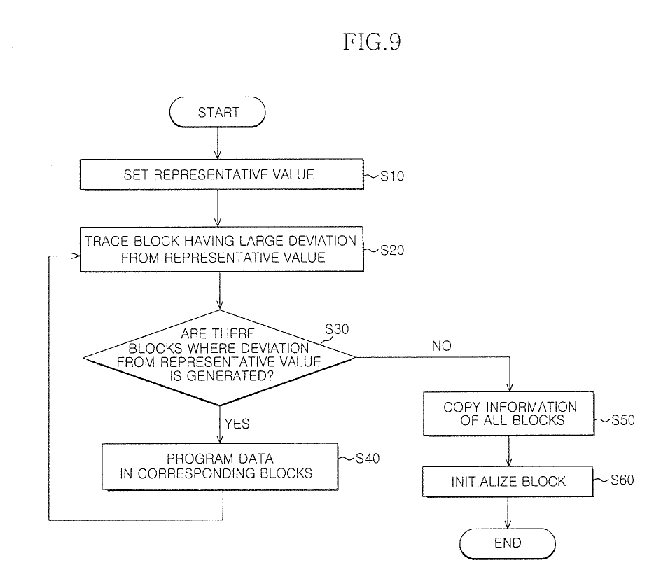

FIG. 9 is a flowchart illustrating a method of controlling a solid state storage system 100 shown in FIG. 1.

Referring to FIGS. 1 to 9, a method of controlling the solid state storage system 100 according to one embodiment will be described.

First, the MCU 130 according to one embodiment sets the representative value (S10).

The representative value RV is set in consideration of a maximum write count in each block, the size of each block, and the number of pages in each block.

The MCU 130 traces a block that has the largest deviation from the set representative value RV (S20).

That is, the block that has the largest deviation from the representative value indicates a block or an area that has the lowest write frequency in a current state. Accordingly, an area that is used the least in the current state can be newly allocated and traced in order to write data.

Then, it is determined whether a block that has a deviation from the representative value exists (S30).

That is, the operation of tracing the block that has a deviation from the representative value is repeated. If the block that has a deviation from the representative value exists, data is written in the corresponding block (S40). In this case, the blocks in the free block can be controlled to be preferentially allocated.

If the block that has a deviation from the representative value does not exist, this indicates that the data values of the free block and the data block are approximate to the representative value RV, thus, information of all of the blocks are copied into a new plane (S50). Then, the corresponding block is initialized to be allocated to a new block in accordance with a command from the external host (S60).

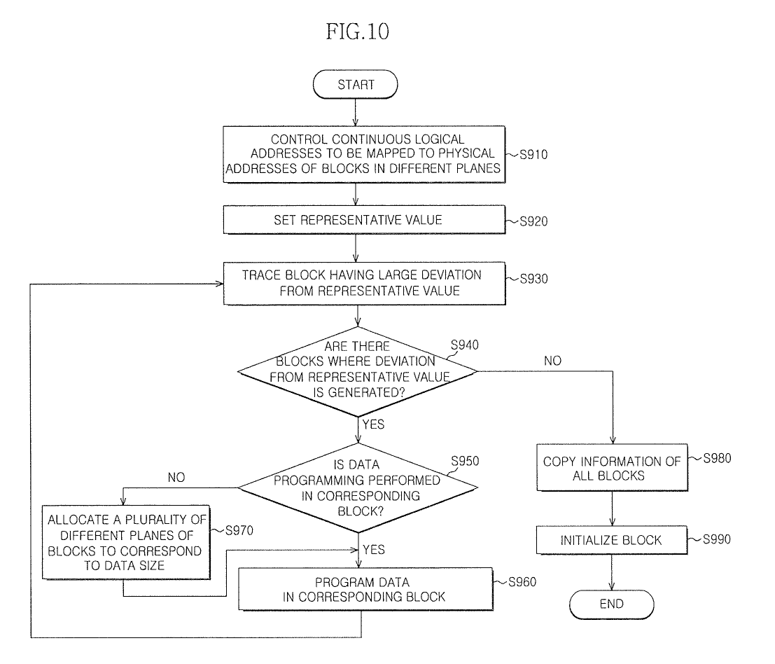

FIG. 10 is a flowchart illustrating a method of controlling a solid state storage system 100 according to another embodiment.

First, the MCU 130 performs a control operation such that continuous logical addresses are mapped to physical addresses of blocks in different planes (S910).

That is, physical locations where data is stored are determined by the logical addresses, the continuous logical addresses are made not to be mapped to the same plane and the same block. As a result, the data that is stored at the locations designated by the continuous logical addresses can be distributed to the blocks of the different planes.

Similar to one embodiment, the MCU 130 sets the representative value (S920) and traces blocks that have large deviations from the set representative value (S930).

Then, it is determined whether a block that has a deviation from the representative value exists (S940). If the block that has a deviation from the representative value exists, it is then determined whether data can be written in the corresponding block (S950). That is, the size of written data is compared with the size of an area where data is written. Accordingly, if the size of data satisfies the size of one allocated data area, data is then written in the corresponding area (S960).

However, if data that has the size larger than the size of the allocated area is written, an area that corresponds to the size of data is additionally allocated. At this time, the blocks are allocated such that data is written in the blocks of the different planes (S970).

Meanwhile, if the block that has a deviation from the representative value does not exist, this indicates that all of the areas are uniformly used, like the representative value. Accordingly, the entire information of the corresponding block is copied into another plane (S980) and the corresponding block is initialized (S990).

As such, according to the embodiments, area allocation can be easily controlled by setting a representative value that becomes an allocation reference of blocks or areas and managing deviations from the representative value. Further, the life time deviation between planes or chips where data is actually stored can be reduced by distributing and mapping physical locations where data is stored.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A solid state storage system, comprising:
a controller configured to:
set a representative value that becomes a block allocation reference in accordance to predetermined information of blocks in a flash memory area,
calculate a data value that becomes life time information in accordance to the predetermined information in a current state for each block,
determine a block where a deviation is generated between the representative value and the data value, and
allocate data to be written to the determined block where the deviation is generated.

2. The solid state storage system of claim 1, wherein the controller further configured to:
set the representative value as a logical threshold value of a reference block as a function of the predetermined information comprising a size of each block in the memory area, a number of pages in each block, and a write count in each block; and
control block allocation from blocks within a same plane as a function of which block within the same plane is associated with a largest deviation between the data value and the representative value.

3. The solid state storage system of claim 2,
wherein the controller is configured to provide the data value by using a size of each block in the flash memory area, the number of pages in each block, and a current write count in each corresponding block as the predetermined information for each corresponding block.

4. The solid state storage system of claim 2,
wherein when the deviation between the data value of each block and the representative value is less than a predetermined value, then the controller is enabled to initialize information to each block.

5. A solid state storage system, comprising:
a flash memory area configured to include a plurality of planes, each plane having a free block and a data block;
a controller configured to:
set a representative value in accordance to a statistical value of predetermined information of the each block,
calculate a data value which is indicative of limited life time information of each block such that the data value is calculated in accordance to the predetermined information in a current state for each block, and
determine priority of block allocation for each block using a deviation between the representative value and the data value of each block; and
a buffer unit configured to update and store the data value for each block when a write operation is performed on each block.

6. The solid state storage system of claim 5,
wherein the controller is configured to determine blocks where the deviation is generated between the representative value and the data value is less than the predetermined value, and configured to preferentially allocate blocks, having deviations furthest from the predetermined value, as new blocks where data is to be written.

7. The solid state storage system of claim 5, wherein the controller includes:
a representative value setting unit configured to set the representative value, corresponding to a logical threshold value of each block, by using the predetermined information comprising the size of each free block, the size of each data block, the number of pages in each block, and a write count in each block; and
a block control unit configured to perform a control operation such that block allocation is made on blocks in the same plane where the deviation between the data value and the representative value is largest.

8. The solid state storage system of claim 7,
wherein the representative value setting unit is configured to provide the data value of each block by using a size of each block in the flash memory area, by using the number of pages in each block, and by using a current write count in each block as the predetermined information for each block.

9. The solid state storage system of claim 7,
wherein the block control unit is configured to initialize information of each block when the deviation between the data value of each block and the representative value is less than or equal to a predetermined value.

10. The solid state storage system of claim 5, wherein the buffer unit includes:
an intra-block data value storage unit configured to store the data value which is updated for each block when a write operation is performed; and
a write count storage unit configured to store a write count for each plane, if the intra-block data value storage unit is initialized when the deviation between the data value and the representative value is less than or equal to the predetermined value.

11. The solid state storage system of claim 10,
wherein, when the write count for each plane is stored whenever the intra-block data value storage unit is initialized, such that the write count is stored by being increased by a logical threshold value indicated by the representative value.

12. The solid state storage system of claim 5,
wherein the controller is configured to include an address mapping control unit, and
the address mapping control unit is configured to perform a control operation such that continuous logical addresses are mapped to physical addresses of blocks in different planes.

13. The solid state storage system of claim 12,
wherein the logical addresses in the same plane are increased by the number of planes.

14. The solid state storage system of claim 12,
wherein the address mapping control unit is configured to control address mapping using a flash translation layer (FTL) conversion.

15. A method of controlling a solid state storage system, comprising:
allowing a controller to set a representative value that becomes a block allocation reference in accordance to predetermined information of blocks and allowing the controller to calculate a data value that becomes life time information according to the predetermined information of each block in a current state for each block;
determining whether there are any blocks in which a deviation between the representative value and the data value is less than or equal to a predetermined value, when data is processed in accordance to a command from an external host;
performing a write operation when corresponding blocks exist that have deviations between the representative value and the data value less than or equal to a predetermined value; and
allowing the controller to initialize information of all of the blocks when the corresponding blocks do not have deviations between the representative value and the data value less than or equal to a predetermined value.

16. The method of claim 15,
wherein the representative value corresponds to a maximum write count of each block is set using a size of each block in the memory area, using a number of pages in each block, and using a write count in each block as the predetermined information.

17. The method of claim 15,
wherein, in the step of determining of whether the corresponding blocks exist, a control operation is performed to determine deviations between the data value and the representative value and the control operation preferentially allocates data to the corresponding blocks that have large deviations which are less than or equal to the predetermined value.

18. The method of claim 15, further comprising:
before the setting of the representative value,
allowing the controller to perform a control operation to map continuous logical addresses to physical addresses of blocks of different planes.

19. A method of controlling a solid state storage system, comprising:
setting, in a write cycle, a representative value as a block allocation reference, and calculating, in the write cycle, a data value as life time information in according to predetermined information of each block in a current state;
determining whether there are blocks in which a deviation between the representative value and the data value is less than or equal to a predetermined value, when data is processed in accordance with a command from an external host; and
performing a write operation in blocks that correspond to having deviations between the representative value and the data value which are less than or equal to the predetermined value and allowing a controller to initialize information of all of the blocks when none of blocks have deviations between the representative value and the data value which are less than or equal to the predetermined value.

20. The method of claim 19,
wherein, when the data value is calculated, the write cycle is counted and the data value is set as the representative value that corresponds to a maximum number of write counts of the blocks.

21. The method of claim 19,
wherein, in the step of determining of whether any blocks have deviations between the representative value and the data value which are less than or equal to a predetermined value, a control operation is performed to determine the deviations and to preferentially allocate any blocks that having large deviations.

22. The method of claim 19, further comprising:
before the setting of the representative value,
allowing the controller to perform a control operation of mapping continuous logical addresses to physical addresses of blocks of different planes.
